(19) United States
(12) Patent Application Publication
(10) Pub. No.: US 2021/0383221 A1
(43) Pub. Date: Dec. 9, 2021

(54) Systems And Methods For Machine-Learned Models With Message Passing Protocols

(71) Applicant: Google LLC, Mountain View, CA (US)

(72) Inventors: Ettore Randazzo, Zurich (CH); Eyvind Niklasson, Zurich (CH); Alexander Mordvintsev, Langnau am Albis (CH)

(21) Appl. No.: 17/337,790

(22) Filed: Jun. 3, 2021

Related U.S. Application Data
(60) Provisional application No. 63/034,109, filed on Jun. 3, 2020.

(51) Int. Cl. G06N 3/08; G06N 3/04

(52) U.S. Cl. CPC G06N 3/08; G06N 3/0445

(57) ABSTRACT

Systems and methods are directed to a computing system. The computing system can include one or more processors and a machine-learned message passing model that is end-to-end differentiable. The machine-learned message passing model can include a plurality of nodes. That each include a machine-learned backmessage generation submodel. Each of the one or more nodes can be configured to receive at least one backmessage from at least one downstream node, generate, using the machine-learned backmessage generation submodel, a multi-dimensional backmessage based on the at least one backmessage, and provide the multi-dimensional backmessage to at least one upstream node. The computing system can, for one or more iterations, update, for each of the one or more nodes, one or more parameters of the machine-learned backmessage generation submodel of the node based on a meta-learning objective function.

### RELATED APPLICATIONS

This application claims priority to and the benefit of U.S. Provisional Patent Application No. 63/034,109, filed Jun. 3, 2020, which is hereby incorporated by reference in its entirety.

### FIELD

The present disclosure relates generally to message passing based machine-learned model(s). More particularly, the present disclosure relates to underlying machine-learned model architecture(s) and learning technique(s) based on message passing protocols.

### BACKGROUND

With the rapid development of machine-learning technologies, conventional techniques have largely converged to using gradient-based learning techniques and architecture(s). However, machine-learned models utilizing these gradient-based approaches often suffer from significant limitations. As an example, gradient-based models are generally prone to overfitting. As another example, gradient-based models can exhibit significant “forgetting” behavior. As yet another example, gradient-based models can suffer from vanishing or exploding gradients.

### SUMMARY

Aspects and advantages of embodiments of the present disclosure will be set forth in part in the following description, or can be learned from the description, or can be learned through practice of the embodiments.

One example aspect of the present disclosure is directed to a computing system for training a machine-learned message passing model. The computing system can include one or more processors. The computing system can include a machine-learned message passing model that is end-to-end differentiable. The machine-learned message passing model can include a plurality of nodes. Each of one or more nodes of the plurality of nodes can respectively include a machine-learned backmessage generation submodel. Each of the one or more nodes can be configured to receive at least one backmessage from at least one downstream node that is located downstream from the node, wherein the at least one backmessage is generated based on a training output of the machine-learned message passing model. Each of the one or more nodes can be configured to generate, using the machine-learned backmessage generation submodel, a multi-dimensional backmessage based on the at least one backmessage received by the node from the at least one downstream node. Each of the one or more nodes can be configured to provide the multi-dimensional backmessage to at least one upstream node that is located upstream from the node. The computing system can include a first set of instructions that, when executed by the one or more processors, cause the computing system to perform operations. The operations can include, for one or more iterations, updating, for each of the one or more nodes, one or more parameters of the machine-learned backmessage generation submodel of the node based on a meta-learning objective function.

Another aspect of the present disclosure is directed to a computer-implemented method for processing data using a machine-learned message passing model. The method can include obtaining input data, wherein the input data is associated with a task. The method can include inputting the input data to the machine-learned message passing model trained to perform the task associated with the input data, wherein the machine-learned message passing model includes a plurality of nodes, each node of the plurality of nodes trained using at least a machine-learned backmessage generation submodel of the node. The method can include receiving, as an output of the machine-learned message passing model, output data, wherein the output data is based at least in part on the input data and corresponds to the task associated with the input data.

Another aspect of the present disclosure is directed to one or more tangible, non-transitory computer readable media storing computer-readable instructions that when executed by one or more processors cause the one or more processors to perform operations. The operations can include obtaining training data and a machine-learned message passing model, wherein the machine-learned message passing model includes a plurality of nodes, wherein each of one or more nodes of the plurality of nodes can respectively include a machine-learned backmessage generation submodel. Each of the one or more nodes can be configured to receive at least one backmessage from at least one downstream node that is located downstream from the node, wherein the at least one backmessage is generated based on a training output of the machine-learned message passing model. Each of the one or more nodes can be configured to generate, using the machine-learned backmessage generation submodel, a multi-dimensional backmessage based on the at least one backmessage received by the node from the at least one downstream node. Each of the one or more nodes can be configured to provide the multi-dimensional backmessage to at least one upstream node that is located upstream from the node. The operations can include, for one or more iterations, inputting the training data to the machine-learned message passing model to receive the training output. The operations can include, for one or more iterations, updating, for each of the one or more nodes, one or more parameters of the node based on the at least one backmessage received by the node.

Other aspects of the present disclosure are directed to various systems, apparatuses, non-transitory computer-readable media, user interfaces, and electronic devices.

These and other features, aspects, and advantages of various embodiments of the present disclosure will become better understood with reference to the following description and appended claims. The accompanying drawings, which are incorporated in and constitute a part of this specification, illustrate example embodiments of the present disclosure and, together with the description, serve to explain the related principles.

### BRIEF DESCRIPTION OF THE DRAWINGS

Detailed discussion of embodiments directed to one of ordinary skill in the art is set forth in the specification, which makes reference to the appended figures, in which:

FIG. 1A depicts a block diagram of an example computing system that performs machine-learned operations using a machine-learned message passing model according to example embodiments of the present disclosure.

FIG. 1B depicts a block diagram of an example computing device that performs meta-learning of a machine-learned message passing model according to example embodiments of the present disclosure.

FIG. 1C depicts a block diagram of an example computing device that performs machine-learned operations using a meta-learned machine-learned message passing model according to example embodiments of the present disclosure.

FIG. 2A depicts a block diagram of a portion of an example machine-learned message passing model according to example embodiments of the present disclosure.

FIG. 2B depicts a block diagram of an example node of the machine-learned message passing model according to example embodiments of the present disclosure.

FIG. 3 depicts a flow chart diagram of an example method to perform meta-learning of a machine-learned message passing model according to example embodiments of the present disclosure.

Reference numerals that are repeated across plural figures are intended to identify the same features in various implementations.

### DETAILED DESCRIPTION

### Overview

Generally, the present disclosure is directed to message passing protocol(s) for training machine-learned model(s). More particularly, systems and methods of the present disclosure are directed to utilizing message passing learning protocol(s) to structure the architecture of a machine-learned model so that conventional components of the machine-learned model (e.g., weights, biases, activation functions, etc.) can be individually optimized by associated machine-learned submodel(s) that are organized and utilized as node(s) in a directed graph. As an example, an end-to-end differentiable machine-learned message passing model can include a plurality of nodes that each correspond to a component of the machine-learned message passing model (e.g., an activation function, a weight, a loss, a bias, etc.). One or more of these nodes can each include a machine-learned backmessage generation submodel (e.g., a multi-layer perceptron, a model including gated recurrent unit(s), a model including long short-term memory unit(s), etc.). When training the machine-learned message passing model, each of these nodes can be configured to receive backmessage(s) from downstream nodes that are based on a training output of the message passing model. After receiving the backmessage(s), each of the node(s) can generate multidimensional backmessage(s) based on the received backmessage(s). Each of the node(s) can then provide the multidimensional backmessage(s) to upstream node(s). During training, parameters of the machine-learned backmessage generation submodel for each of these node(s) can be updated in a differentiable, end-to-end fashion based on a meta-learning objective function. In such fashion, a machine-learned model (e.g., the message passing model) utilizing a message passing learning protocol (e.g., MPLP) can be optimally meta-learned so that the machine-learned model can quickly adapt to various tasks with sparse training data (e.g., image classification, etc.).

More particularly, conventional machine-learning techniques have mostly trended towards gradient-based approaches. When training a machine-learned model with a gradient-based approach, a training input x is input to the model and the model computes y as a training output (e.g., a forward pass through the model). Next, in a backward pass, a loss function determines a loss by evaluating a difference between y and a ground truth associated with x. A gradient of the upstream loss is determined and then is composed with the gradient function. The parameter(s) of the model are then updated based on the gradient of the loss. However, this gradient-based approach often leads to vanishing/exploding gradients, overfitting of training sets, and significantly detrimental forgetting behavior. Further, the scaling of deep gradient-based networks has led to significant increases in computation and memory requirements.

In response to this problem, aspects of the present embodiment are directed to a message passing learning protocol for machine-learned model(s). Using a message passing learning protocol, a machine-learned model can be represented as a directed graph that includes a plurality of nodes corresponding to “inputs” and “outputs.” The nodes can communicate with each other by passing n-dimensional vectors along directed edges of the directed graph. The machine-learned model represented as the directed graph can be trained using a meta-learning procedure such that the model is able to adapt to a given task.

As an example, any component of a machine-learned message passing model (e.g., a weight, a bias, an activation function, a loss, etc.) can be represented by a node in the directed graph. The node in the directed graph can include value(s), a machine-learned backmessage generation submodel, and a machine-learned node update submodel. The forward pass through the machine-learned model (e.g., providing an input to the model to receive an output) can be accomplished in the same manner as a traditional gradient-based approach. In the backwards training pass (e.g., the adjustment of parameters of the model, etc.), each node can receive a k-dimensional message vector. Based on the k-dimensional message vector, each node can update its own value (e.g., a weight for a node corresponding to a weight, carry states of the node, hidden states of the node, etc.) using a machine-learned node update submodel of the node (e.g., a multilayer perceptron, a long short-term memory unit, a gated recurrent unit, etc.). Further, each of the nodes can backpropagate an additional modified k-dimensional message vector generated using the node's machine-learned backmessage generation submodel (e.g., a multilayer perceptron, a long short-term memory unit, a gated recurrent unit, etc.). The parameters of each of the nodes machine-learned submodel(s) (e.g., the machine-learned backmessage generation submodel and/or the machine-learned node update submodel) can be updated based on a meta-learning objective function that evaluates a training output of the machine-learned message passing model.

More particularly, a computing system can include a machine-learned message passing model. The machine-learned message passing model can, in some implementations, can be or can otherwise include one or more neural networks (e.g., deep neural networks) or the like. Neural networks (e.g., deep neural networks) can be feed-forward neural networks, convolutional neural networks, and/or various other types of neural networks. The machine-learned message passing model can include a plurality of nodes (e.g., organized in a directed graph, etc.). One or more of these nodes can respectively include a machine-learned backmessage generation submodel. Although the machine-learned message passing model is described by some portions of the present disclosure in the context of a neural network, the machine-learned message passing model is not limited to neural network structures but instead can be applied to other structures such as any graph-based structure where some or all of nodes of the graph have the message passing structure(s) or model(s) described herein. As such, multi-dimensional messages (e.g., backmessages, forward messages, etc.) described in the present disclosure can be sent to any node in the directed graph, regardless of the position and/or location of the sending node(s) and the receiving node(s).

In some implementations, the machine-learned backmessage generation submodel can be or otherwise include one or more neural network units. As an example, the machine-learned backmessage generation submodel can include one or more multi-layer perceptrons. As another example, the machine-learned backmessage generation submodel can include long short-term memory units. As yet another the machine-learned backmessage generation submodel can include gated recurrent units. Alternatively, or additionally, in some implementations, the machine-learned backmessage generation submodel can be or otherwise include one or more additional neural networks (e.g., a recurrent neural network, a multi-layer perceptron, etc.).

The one or more nodes of the plurality of nodes of the machine-learned message passing model can each be configured to receive at least one backmessage from at least one downstream node that is located downstream from the node. As an example, the plurality of nodes of the machine-learned message passing model can be structured in a series of consecutive layers that sequentially process an input to generate an output. The last layer of node(s) of the machine-learned message passing model (e.g., the layer of node(s) that generate the final output) can be considered the most “downstream” node(s) of the machine-learned message passing model, while the first layer of node(s) (e.g., the layer of nodes that first processes the input, etc.) can be considered the most “upstream” node(s) of the machine-learned message passing model. It should be noted that, as described, a node can be considered downstream of itself. More particularly, a node can send a backmessage to itself (e.g., a message including a serializable list of operations computed in order to update the status of the node, etc.) and the backmessage can be received as a backmessage from a downstream node. As such, a node included in a last “layer” of the machine-learned message passing model can receive a backmessage from a downstream node.

In some implementations, the backmessage received by the node(s) from the downstream node(s) can be a multi-dimensional backmessage (e.g., a multi-dimensional vector, etc.). The multi-dimensional backmessage can be represented by or structured as any conventional multi-dimensional data structure. The multi-dimensional backmessage can be based on, include, or otherwise represent a serializable list of operations that a node (e.g., a downstream node, etc.) computed in order to update the state of the node. Alternatively, or additionally, in some implementations, the message can be a latent space encoding configured to provide node update information to the node.

The one or more nodes of the plurality of nodes of the machine-learned message passing model can each be configured to generate, using the machine-learned backmessage generation submodel, a multi-dimensional backmessage based on the at least one backmessage received by the node from the at least one downstream node. The one or more nodes can each be configured to then provide the generated multi-dimensional backmessage to upstream node(s) located upstream from the downstream node(s). In such fashion, the nodes can backpropagate multi-dimensional backmessages from the last “layer” of node(s) in the machine-learned message passing model to the first “layer” of node(s).

It should be noted that the machine-learned message passing model is described as being structured in “layers” merely to more aptly illustrate the various embodiments of the present disclosure. More particularly, the machine-learned message passing model does not necessarily need to be structured in layers, and can instead be structured in any manner that facilitates communication of messages between nodes of the machine-learned message passing model.

More particularly, a feed-forward neural network can be seen as a special case of a directed graph. The types of nodes can correspond to components of a neural network (e.g., weights, biases, activations, losses, etc.). Every node can include a forward and a backward arrow. The forward arrow can compute one-dimensional outputs from one-dimensional inputs, as performed in conventional neural network architectures. As an example, a forward step of a weight can be represented as y=w·x. The machine-learned message passing model can explicitly store the input values received to later be passed in the backward pass (e.g., how backpropagation requires the input values to compute gradients, etc.).

However, under a message passing learning protocol (e.g., the protocol of the machine-learned message passing model, etc.), the backward pass through the machine-learned message passing model (e.g., the communication of backmessages between nodes, etc.) can utilize every node to compute a backmessage to send back to an upstream node, given its forward input received in the forward pass, the backmessage received from the one or more downstream node(s), and any internal states of the node (e.g., weights or bias values, GRU/LSTM carry/hidden states, a nodes embedding for personalization, etc.). It should be noted that this framework allows for a variety of possible architectures, and as such is not limited to traditional feed forward neural network implementations.

As an example, this function (e.g., the message passing rule, etc.) can be formally represented as a machine-learned backmessage generation submodel g. As an example, for a node i, the message mᵢ can be computed from a message mⱼ, forward input xᵢ and internal states hᵢ (weight/bias values, carry states):

mᵢ^{t}=g(mⱼ, xᵢ, hᵢ)

However, losses and activation components of the machine-learned message passing model generally have no parameters to update, so the internal states can generally consist of carry states, if a stateful learner is utilized. Moreover, while a message mⱼ can be k-dimensional with typically k>1, the input message to a loss function can generally be 1-dimensional, and can be considered as the loss itself. However, it should be noted that while the input message (e.g., the message received by these node(s) during the forward pass, etc.) can be 1-dimensional, the backmessage generated by these nodes (e.g., loss node(s), activation node(s), etc.) can be multi-dimensional.

Further, in some implementations, each of the one or more nodes can be updated with the machine-learned node update submodel of the node. More particularly, some node(s) (e.g., weight node(s), bias node(s), etc.) can utilize their own machine-learned node update submodel to determine a node update f, wherein:

Δwᵢⱼ^{t}=f(mⱼ, xᵢ^{t}, hᵢ^{t})

for a batch of size B, f can be computed B times, and then averaged to compute the final update:

wᵢⱼ^{t+1}=wᵢⱼ^{t}+ΣBΔwᵢⱼ^{t}

which can be applied to the node to update the node. More particularly, the machine-learned node update submodel can generate a plurality of updates to the node (e.g., corresponding to a batch size of a training input batch, etc.) and can then average the plurality of updates to receive a final update to apply to the node.

As an example, given a traditional dense machine-learned message passing model layer of size N*M, some of the messages can require replication, while others may require aggregation. As such, a line of nodes M (e.g., bias node(s), etc.) can replicate each of their generated messages N times, as they are connected to N nodes (e.g., weight node(s), etc.). Similarly, the output message of a dense layer of node(s) can be expected to be N messages. This can be performed, in some implementations, by averaging the messages for each “column” of nodes (e.g., a layer, a grouping of nodes by node type, etc.).

It should be noted that, in some implementations, the nodes and respective f functions (e.g., machine-learned node update submodels) and g functions (e.g., machine-learned backmessage generation submodels), can be implemented either by stateful or stateless models. As an example, stateful gated recurrent unit based models can be utilized (e.g., as a multilayer perceptron model, in addition to a multilayer perceptron model, etc.). For example, the stateful gated recurrent unit based models can be represented formally as:

u=σ(x*Wᵤₓ+c^{t}*W_{uc}+bᵤ)

r=σ(x*Wᵣₓ+c^{t}*W_{rc}+bᵣ)

c^{t+1}=u·c^{t}+(1−u)·tanh(MLPₓ(x)+MLP_{c}(c^{t}·r)+bₙ)

wherein the multilayer perceptrons (e.g., MLP's, etc.) can include two hidden layers of different sizes (e.g., size 80 and 40 respectively, etc.) with associated activation functions (e.g., ReLu activation functions, etc.). Some of the carry states can be considered as output messages, and weight updates for nodes corresponding to weights and biases. Alternatively, in some implementations, a stateless version of the above example can be utilized. For example, a multilayer perceptron can be used for f (e.g., the machine-learned node update submodel) and for g (e.g., the machine-learned backmessage generation submodel). Both of the submodels can include two hidden layers of size 80 and 40 respectively with ReLu activations, and a tanh activation for the final layer.

In some implementations, one or more nodes of the machine-learned message passing model can include one or more embeddings. More particularly, each of one or more nodes of the nodes of the machine-learned message passing model can include one or more embeddings configured to add additional personalization to each of the node(s). The utilization and implementation of embeddings and embedding generation techniques can be performed using any conventional embedding techniques (e.g., machine-learned embedding generation, conventional embedding generation, etc.).

In some implementations, the machine-learned message passing model can be initialized before training the model and/or using the model. More particularly, for any f inputs (e.g., inputs to the machine-learned node update submodel, etc.) and g inputs (e.g., inputs to the machine-learned backmessage generation submodel, etc.), input messages, carry states, inputs to the forward step, and optional weights can all possess different means and magnitudes. As such, the differences between means and magnitudes can be reduced or eliminated by performing one or more minibatch operations and standardizing the inputs to the machine-learned submodels individually. The values used (e.g., mean, standard deviation, etc.), can be kept fixed, and therefore can be reused thorough the machine-learned submodels lifetime. Similarly, the outputs of the f models (e.g., the machine-learned node update submodel(s) can be bounded by (−1, 1) by a tanh function. This range can cause the model to be too sensitive to changes during early training. As such, the outputs of the machine-learned node update submodels can be translated to have a mean of zero, and can be scaled down to a predetermined maximum size (e.g., the layer's W standard deviation divided by 5, etc.). In some implementations, the output scaling can be the only trainable variable. Alternatively, in some implementations, other variables can be trained in addition to output scaling. It should be noted that batch normalization is not necessarily the only configuration that can be utilized by the present disclosure. Instead, any different conventional standardization techniques, such as batch normalization, can be utilized.

In some implementations, a “line” of nodes (e.g., one or more weight nodes, one or more bias nodes, one or more activation nodes, one or more loss nodes, etc.) can share a machine-learned backmessage generation submodel and a machine-learned node update submodel. More particularly, the nodes in a “line” can use the same model parameters for each of their own respective machine-learned submodels. Alternatively, or additionally, each node in a layer can share the same parameters in a substantially similar manner.

The computing system can train the machine-learned message passing model using a meta-learning objective function. More particularly, in some implementations, a cross-validation loss can be evaluated by the meta-learning objective function after performing k-step learning (e.g., evaluating the quality of the learnt parameters on unseen data). Additionally, or alternatively, the meta-learning objective function can further evaluate a “hint loss” that, after every step, reinforces the model to correctly classify the input-output pairs included in training input data as it is observed. Additionally, in some implementations, the meta-learning objective function can be evaluated using an adaptive optimizer (e.g., ADAM, etc.) to normalize the gradient(s) for each variable associated with a node.

The present disclosure provides a number of technical effects and benefits. As one example technical effect and benefit, the systems and methods of the present disclosure allow for machine-learned training techniques that require significantly fewer training iterations (e.g., “few-shot” training) while also providing highly accurate results. For example, traditional gradient descent approaches to machine-learned model training can require significant computational resources—often requiring investment in expensive, specialized computational hardware resources. By significantly reducing the number of training iterations needed to accurately train a machine-learned model, the message passing learning protocol of the present disclosure significantly reduces the computational and energy resources required to train a machine-learned model, while also reducing the amount of specialized computational hardware required.

In some implementations, the input to the machine-learned model(s) of the present disclosure can be image data. The machine-learned model(s) can process the image data to generate an output. As an example, the machine-learned model(s) can process the image data to generate an image recognition output (e.g., a recognition of the image data, a latent embedding of the image data, an encoded representation of the image data, a hash of the image data, etc.). As another example, the machine-learned model(s) can process the image data to generate an image segmentation output. As another example, the machine-learned model(s) can process the image data to generate an image classification output. As another example, the machine-learned model(s) can process the image data to generate an image data modification output (e.g., an alteration of the image data, etc.). As another example, the machine-learned model(s) can process the image data to generate an encoded image data output (e.g., an encoded and/or compressed representation of the image data, etc.). As another example, the machine-learned model(s) can process the image data to generate an upscaled image data output. As another example, the machine-learned model(s) can process the image data to generate a prediction output.

In some implementations, the input to the machine-learned model(s) of the present disclosure can be text or natural language data. The machine-learned model(s) can process the text or natural language data to generate an output. As an example, the machine-learned model(s) can process the natural language data to generate a language encoding output. As another example, the machine-learned model(s) can process the text or natural language data to generate a latent text embedding output. As another example, the machine-learned model(s) can process the text or natural language data to generate a translation output. As another example, the machine-learned model(s) can process the text or natural language data to generate a classification output. As another example, the machine-learned model(s) can process the text or natural language data to generate a textual segmentation output. As another example, the machine-learned model(s) can process the text or natural language data to generate a semantic intent output. As another example, the machine-learned model(s) can process the text or natural language data to generate an upscaled text or natural language output (e.g., text or natural language data that is higher quality than the input text or natural language, etc.). As another example, the machine-learned model(s) can process the text or natural language data to generate a prediction output.

In some implementations, the input to the machine-learned model(s) of the present disclosure can be speech data. The machine-learned model(s) can process the speech data to generate an output. As an example, the machine-learned model(s) can process the speech data to generate a speech recognition output. As another example, the machine-learned model(s) can process the speech data to generate a speech translation output. As another example, the machine-learned model(s) can process the speech data to generate a latent embedding output. As another example, the machine-learned model(s) can process the speech data to generate an encoded speech output (e.g., an encoded and/or compressed representation of the speech data, etc.). As another example, the machine-learned model(s) can process the speech data to generate an upscaled speech output (e.g., speech data that is higher quality than the input speech data, etc.). As another example, the machine-learned model(s) can process the speech data to generate a textual representation output (e.g., a textual representation of the input speech data, etc.). As another example, the machine-learned model(s) can process the speech data to generate a prediction output.

In some implementations, the input to the machine-learned model(s) of the present disclosure can be latent encoding data (e.g., a latent space representation of an input, etc.). The machine-learned model(s) can process the latent encoding data to generate an output. As an example, the machine-learned model(s) can process the latent encoding data to generate a recognition output. As another example, the machine-learned model(s) can process the latent encoding data to generate a reconstruction output. As another example, the machine-learned model(s) can process the latent encoding data to generate a search output. As another example, the machine-learned model(s) can process the latent encoding data to generate a reclustering output. As another example, the machine-learned model(s) can process the latent encoding data to generate a prediction output.

In some implementations, the input to the machine-learned model(s) of the present disclosure can be statistical data. The machine-learned model(s) can process the statistical data to generate an output. As an example, the machine-learned model(s) can process the statistical data to generate a recognition output. As another example, the machine-learned model(s) can process the statistical data to generate a prediction output. As another example, the machine-learned model(s) can process the statistical data to generate a classification output. As another example, the machine-learned model(s) can process the statistical data to generate a segmentation output. As another example, the machine-learned model(s) can process the statistical data to generate a segmentation output. As another example, the machine-learned model(s) can process the statistical data to generate a visualization output. As another example, the machine-learned model(s) can process the statistical data to generate a diagnostic output.

In some implementations, the input to the machine-learned model(s) of the present disclosure can be sensor data. The machine-learned model(s) can process the sensor data to generate an output. As an example, the machine-learned model(s) can process the sensor data to generate a recognition output. As another example, the machine-learned model(s) can process the sensor data to generate a prediction output. As another example, the machine-learned model(s) can process the sensor data to generate a classification output. As another example, the machine-learned model(s) can process the sensor data to generate a segmentation output. As another example, the machine-learned model(s) can process the sensor data to generate a segmentation output. As another example, the machine-learned model(s) can process the sensor data to generate a visualization output. As another example, the machine-learned model(s) can process the sensor data to generate a diagnostic output. As another example, the machine-learned model(s) can process the sensor data to generate a detection output.

With reference now to the Figures, example embodiments of the present disclosure will be discussed in further detail.

### EXAMPLE DEVICES AND SYSTEMS

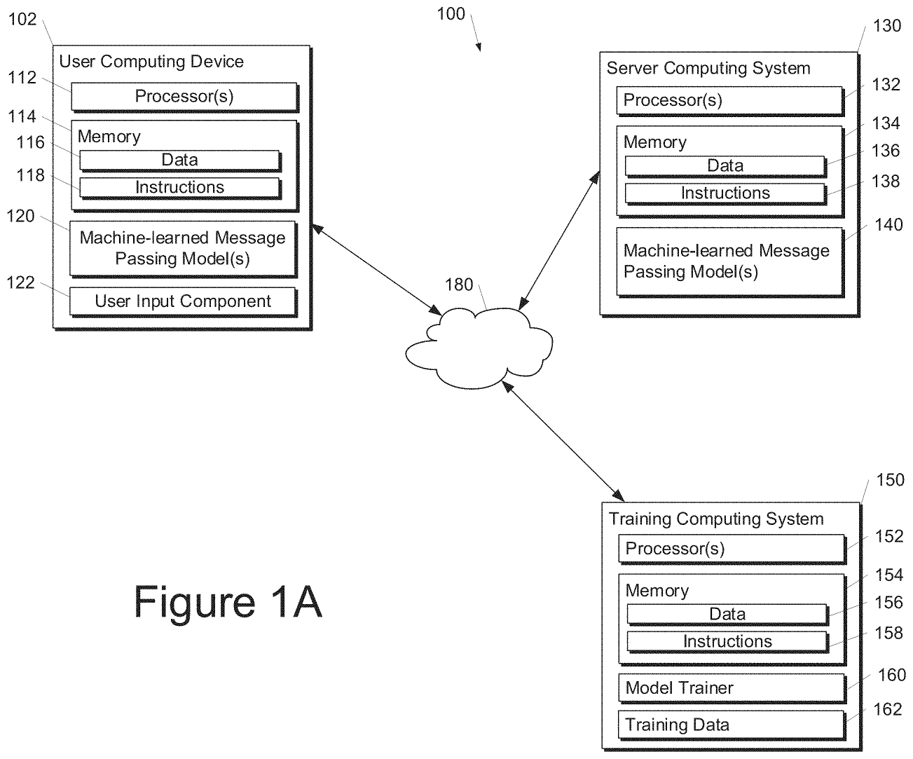

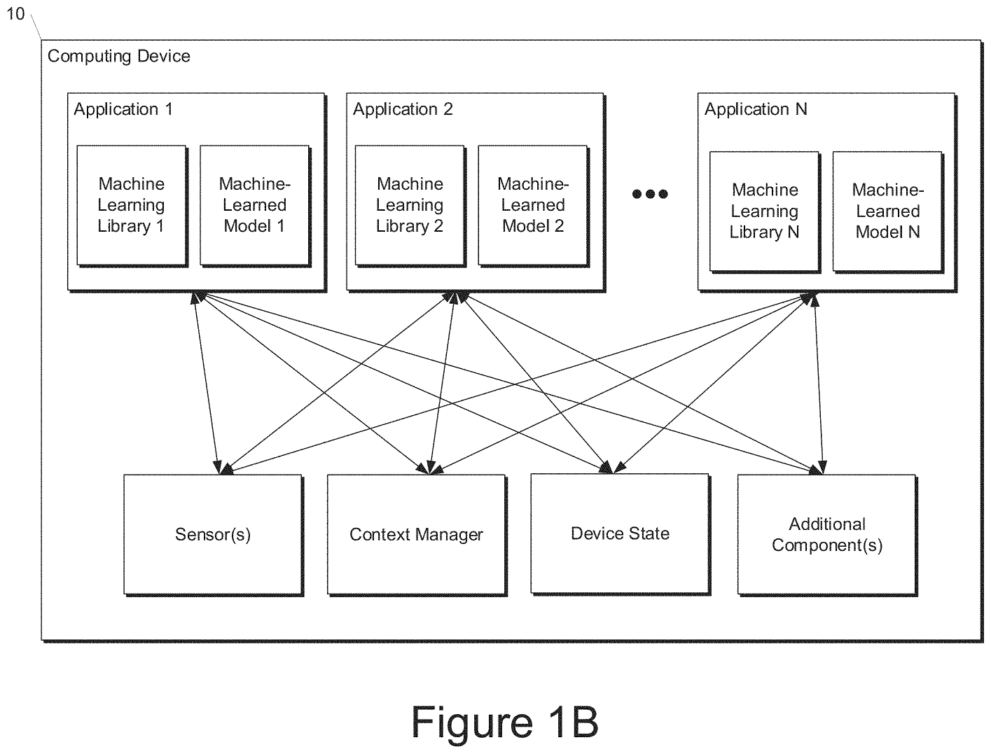

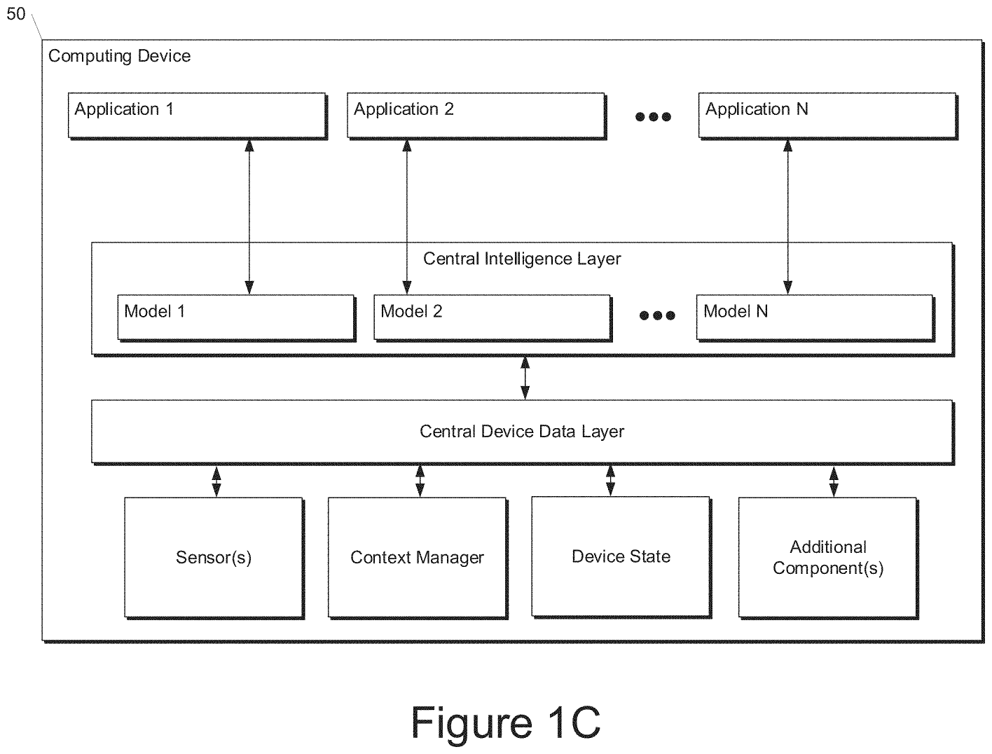

FIG. 1A depicts a block diagram of an example computing system 100 that performs machine-learned operations using a machine-learned message passing model according to example embodiments of the present disclosure. The system 100 includes a user computing device 102, a server computing system 130, and a training computing system 150 that are communicatively coupled over a network 180.

The user computing device 102 can be any type of computing device, such as, for example, a personal computing device (e.g., laptop or desktop), a mobile computing device (e.g., smartphone or tablet), a gaming console or controller, a wearable computing device, an embedded computing device, or any other type of computing device.

The user computing device 102 includes one or more processors 112 and a memory 114. The one or more processors 112 can be any suitable processing device (e.g., a processor core, a microprocessor, an ASIC, a FPGA, a controller, a microcontroller, etc.) and can be one processor or a plurality of processors that are operatively connected. The memory 114 can include one or more non-transitory computer-readable storage mediums, such as RAM, ROM, EEPROM, EPROM, flash memory devices, magnetic disks, etc., and combinations thereof. The memory 114 can store data 116 and instructions 118 which are executed by the processor 112 to cause the user computing device 102 to perform operations.

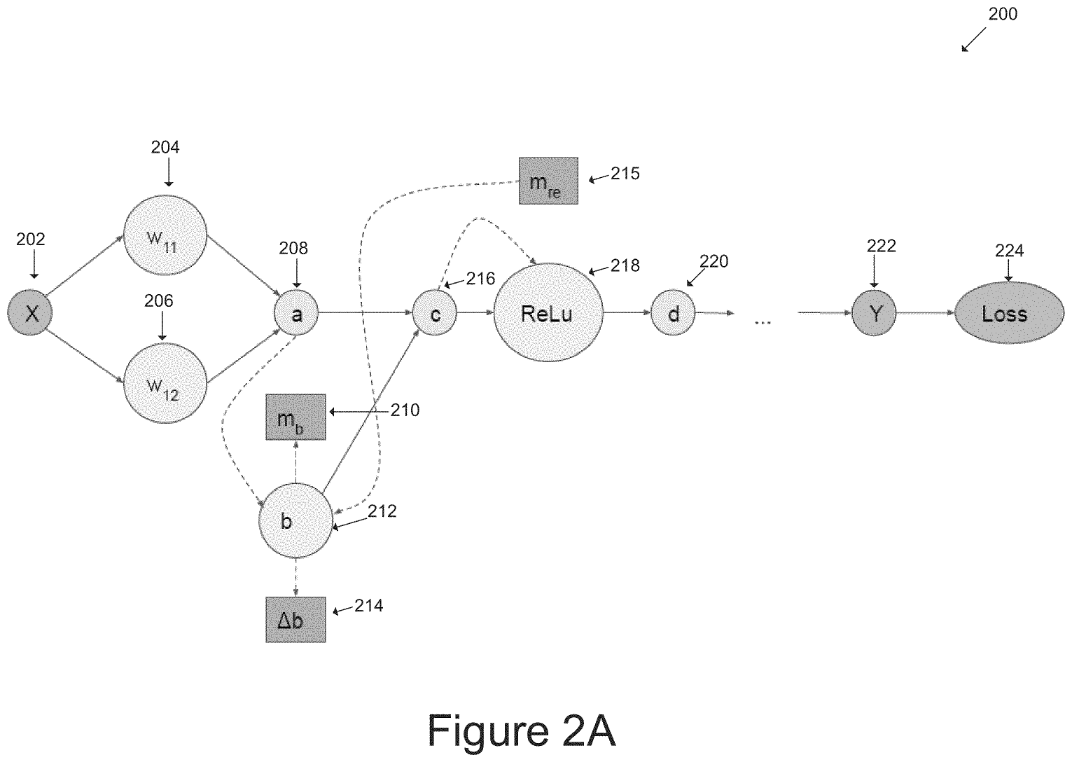

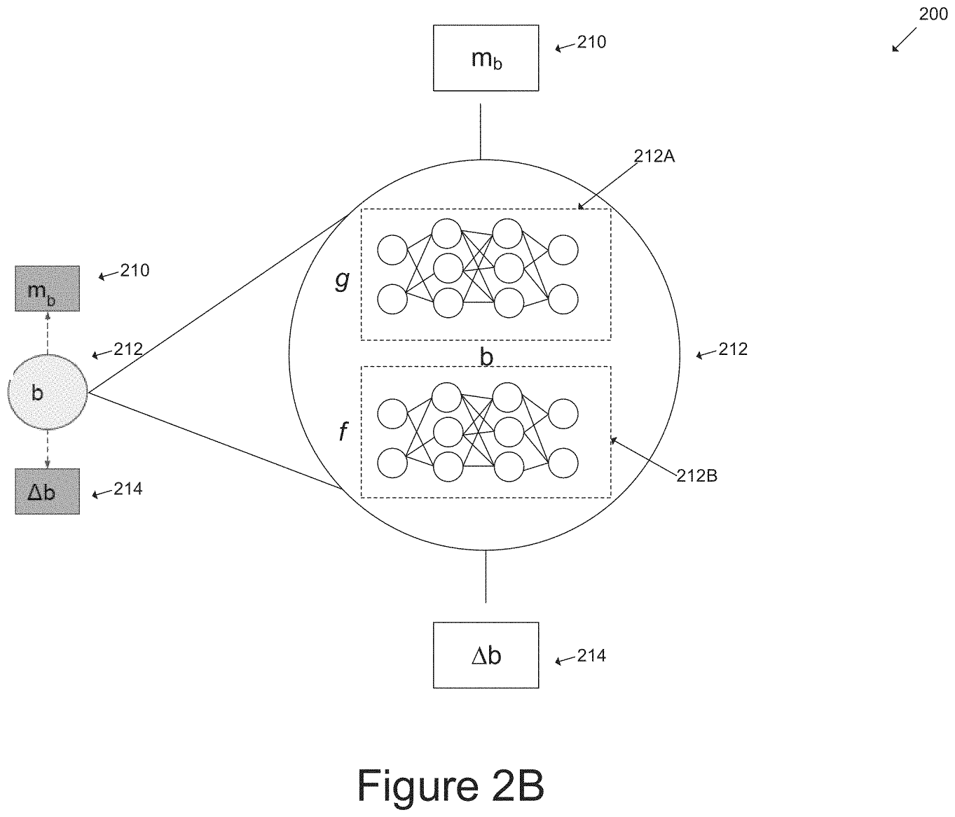

In some implementations, the user computing device 102 can store or include one or more machine-learned message passing models 120. For example, the machine-learned message passing models 120 can be or can otherwise include various machine-learned models such as neural networks (e.g., deep neural networks) or other types of machine-learned models, including non-linear models and/or linear models. Neural networks can include feed-forward neural networks, recurrent neural networks (e.g., long short-term memory recurrent neural networks), convolutional neural networks or other forms of neural networks. Example machine-learned message passing models 120 are discussed with reference to FIG. 2.

In some implementations, the one or more machine-learned message passing models 120 can be received from the server computing system 130 over network 180, stored in the user computing device memory 114, and then used or otherwise implemented by the one or more processors 112. In some implementations, the user computing device 102 can implement multiple parallel instances of a single machine-learned message passing model 120 (e.g., to perform parallel machine-learned operations across multiple instances of the machine-learned message passing model 120).

More particularly, the machine-learned message passing model 120 can include a plurality of nodes that each correspond to a component of the machine-learned message passing model 120 (e.g., an activation function, a weight, a loss, a bias, etc.). One or more of these nodes can each include a machine-learned backmessage generation submodel (e.g., a gated recurrent unit, long short-term memory unit, multi-layer perceptron, etc.). When training the machine-learned message passing model 120, each of these nodes can be configured to receive backmessage(s) from downstream nodes that are based on a training output of the message passing model. After receiving the backmessage(s), each of the node(s) can generate multidimensional backmessage(s) based on the received backmessage(s). Each of the node(s) can then provide the multidimensional backmessage(s) to upstream node(s). During training, parameters of the machine-learned passing model 120 (e.g., parameter(s) of the backmessage generation submodel for each of these node(s), etc.) can be updated in a differentiable, end-to-end fashion based on a meta-learning objective function. In such fashion, a machine-learned model (e.g., the message passing model 120) utilizing a message passing learning protocol (e.g., MPLP) can be optimally meta-learned so that the machine-learned message passing model 120 can quickly adapt to various tasks with sparse training data (e.g., image classification, etc.).

Additionally, or alternatively, one or more machine-learned message passing model models 140 can be included in or otherwise stored and implemented by the server computing system 130 that communicates with the user computing device 102 according to a client-server relationship. For example, the machine-learned message passing model models 140 can be implemented by the server computing system 140 as a portion of a web service (e.g., an image classification service, an image recognition service, etc.). Thus, one or more models 120 can be stored and implemented at the user computing device 102 and/or one or more models 140 can be stored and implemented at the server computing system 130.

The user computing device 102 can also include one or more user input component 122 that receives user input. For example, the user input component 122 can be a touch-sensitive component (e.g., a touch-sensitive display screen or a touch pad) that is sensitive to the touch of a user input object (e.g., a finger or a stylus). The touch-sensitive component can serve to implement a virtual keyboard. Other example user input components include a microphone, a traditional keyboard, or other means by which a user can provide user input.

The server computing system 130 includes one or more processors 132 and a memory 134. The one or more processors 132 can be any suitable processing device (e.g., a processor core, a microprocessor, an ASIC, a FPGA, a controller, a microcontroller, etc.) and can be one processor or a plurality of processors that are operatively connected. The memory 134 can include one or more non-transitory computer-readable storage mediums, such as RAM, ROM, EEPROM, EPROM, flash memory devices, magnetic disks, etc., and combinations thereof. The memory 134 can store data 136 and instructions 138 which are executed by the processor 132 to cause the server computing system 130 to perform operations.

In some implementations, the server computing system 130 includes or is otherwise implemented by one or more server computing devices. In instances in which the server computing system 130 includes plural server computing devices, such server computing devices can operate according to sequential computing architectures, parallel computing architectures, or some combination thereof.

As described above, the server computing system 130 can store or otherwise include one or more machine-learned message passing model models 140. For example, the models 140 can be or can otherwise include various machine-learned models. Example machine-learned models include neural networks or other multi-layer non-linear models. Example neural networks include feed forward neural networks, deep neural networks, recurrent neural networks, and convolutional neural networks. Example models 140 are discussed with reference to FIG. 2.

The user computing device 102 and/or the server computing system 130 can train the models 120 and/or 140 via interaction with the training computing system 150 that is communicatively coupled over the network 180. The training computing system 150 can be separate from the server computing system 130 or can be a portion of the server computing system 130.

The training computing system 150 includes one or more processors 152 and a memory 154. The one or more processors 152 can be any suitable processing device (e.g., a processor core, a microprocessor, an ASIC, a FPGA, a controller, a microcontroller, etc.) and can be one processor or a plurality of processors that are operatively connected. The memory 154 can include one or more non-transitory computer-readable storage mediums, such as RAM, ROM, EEPROM, EPROM, flash memory devices, magnetic disks, etc., and combinations thereof. The memory 154 can store data 156 and instructions 158 which are executed by the processor 152 to cause the training computing system 150 to perform operations. In some implementations, the training computing system 150 includes or is otherwise implemented by one or more server computing devices.

The training computing system 150 can include a model trainer 160 that trains the machine-learned models 120 and/or 140 stored at the user computing device 102 and/or the server computing system 130 using various training or learning techniques, such as, for example, backwards propagation of errors. For example, a meta-learning objective function can be backpropagated through the model(s) using message passing between nodes of the model(s). Various loss functions can be used such as mean squared error, likelihood loss, cross entropy loss, hinge loss, and/or various other loss functions. Message passing techniques can be used to iteratively update the parameters of the machine-learned message passing model 120/140 and/or the parameters of one or more submodels of the machine-learned message passing models 120/140 (e.g., machine-learned backmessage generation submodels, machine-learned node update submodels, etc.) over a number of training iterations.

In some implementations, performing backwards propagation of errors can include performing truncated backpropagation through time. The model trainer 160 can perform a number of generalization techniques (e.g., weight decays, dropouts, etc.) to improve the generalization capability of the models being trained.

In particular, the model trainer 160 can train the machine-learned message passing models 120 and/or 140 based on a set of training data 162. The training data 162 can include, for example, a dataset including a plurality of tasks (e.g., a dataset commonly utilized for meta-learning on sinusoidal fitting, etc.). The dataset samples a set of tasks for each training step, defined by an amplitude in the range A∈[0.1,0.5] and phase p∈[0,π]. An inner batch can be sampled of size ib of x coordinates within the range [−5, 5] and compute its respective y=Asin(x+p). This can be repeated k times, for a k-step learning. Different kinds of training can be performed. As an example, fitting from scratch training can be performed for sinusoidal fitting. As another example, training configured for meta-learning the algorithm and the prior can be performed. In some implementations, a message size of 8 across all sinusoidal training can be utilized.

Additionally, in some implementations, a random initialization of selected neural network architecture(s) can be sampled (e.g., an architecture of size 1×20×20×1, ReLu activations, etc.). This can be done to ensure that the meta-learning objective function does not overfit the machine-learned message passing model to a specific initialization configuration. In some implementations, a stateful learner can be used. In some implementations, a 5-step learning process can be used (e.g., with an inner batch size of 10, etc.).

In some implementations, an outer batch size of 4 can be used with a cross-validation loss at the end of the 5-step learning, and a hint loss at every step. The loss used can be an L2loss for both cross-validation and hint losses. The L2 loss can also the final node of the network (e.g., the loss in the initial message in the backward stage can be L2).

In some implementations, if the user has provided consent, the training examples can be provided by the user computing device 102. Thus, in such implementations, the model 120 provided to the user computing device 102 can be trained by the training computing system 150 on user-specific data received from the user computing device 102. In some instances, this process can be referred to as personalizing the model (e.g., using embeddings for the nodes of the machine-learned message passing model, etc.).

The model trainer 160 includes computer logic utilized to provide desired functionality. The model trainer 160 can be implemented in hardware, firmware, and/or software controlling a general purpose processor. For example, in some implementations, the model trainer 160 includes program files stored on a storage device, loaded into a memory and executed by one or more processors. In other implementations, the model trainer 160 includes one or more sets of computer-executable instructions that are stored in a tangible computer-readable storage medium such as RAM hard disk or optical or magnetic media.

The network 180 can be any type of communications network, such as a local area network (e.g., intranet), wide area network (e.g., Internet), or some combination thereof and can include any number of wired or wireless links. In general, communication over the network 180 can be carried via any type of wired and/or wireless connection, using a wide variety of communication protocols (e.g., TCP/IP, HTTP, SMTP, FTP), encodings or formats (e.g., HTML, XML), and/or protection schemes (e.g., VPN, secure HTTP, SSL).

FIG. 1A illustrates one example computing system that can be used to implement the present disclosure. Other computing systems can be used as well. For example, in some implementations, the user computing device 102 can include the model trainer 160 and the training dataset 162. In such implementations, the models 120 can be both trained and used locally at the user computing device 102. In some of such implementations, the user computing device 102 can implement the model trainer 160 to personalize the models 120 based on user-specific data.

FIG. 1B depicts a block diagram of an example computing device 10 that performs meta-learning of a machine-learned message passing model according to example embodiments of the present disclosure. The computing device 10 can be a user computing device or a server computing device.

The computing device 10 includes a number of applications (e.g., applications 1 through N). Each application contains its own machine learning library and machine-learned model(s). For example, each application can include a machine-learned message passing model. Example applications include a text messaging application, an email application, a dictation application, a virtual keyboard application, a browser application, etc.

As illustrated in FIG. 1B, each application can communicate with a number of other components of the computing device, such as, for example, one or more sensors, a context manager, a device state component, and/or additional components. In some implementations, each application can communicate with each device component using an API (e.g., a public API). In some implementations, the API used by each application is specific to that application.

FIG. 1C depicts a block diagram of an example computing device 50 that performs machine-learned operations using a meta-learned machine-learned message passing model according to example embodiments of the present disclosure. The computing device 50 can be a user computing device or a server computing device.

The computing device 50 includes a number of applications (e.g., applications 1 through N). Each application is in communication with a central intelligence layer. Example applications include a text messaging application, an email application, a dictation application, a virtual keyboard application, a browser application, etc. In some implementations, each application can communicate with the central intelligence layer (and model(s) stored therein) using an API (e.g., a common API across all applications).

The central intelligence layer includes a number of machine-learned models. For example, as illustrated in FIG. 1C, a respective machine-learned model (e.g., a model) can be provided for each application and managed by the central intelligence layer. In other implementations, two or more applications can share a single machine-learned model. For example, in some implementations, the central intelligence layer can provide a single model (e.g., a single model) for all of the applications. In some implementations, the central intelligence layer is included within or otherwise implemented by an operating system of the computing device 50.

The central intelligence layer can communicate with a central device data layer. The central device data layer can be a centralized repository of data for the computing device 50. As illustrated in FIG. 1C, the central device data layer can communicate with a number of other components of the computing device, such as, for example, one or more sensors, a context manager, a device state component, and/or additional components. In some implementations, the central device data layer can communicate with each device component using an API (e.g., a private API).

### EXAMPLE MODEL ARRANGEMENTS

FIG. 2A depicts a block diagram of a simplified representative portion of an example machine-learned message passing model 200 according to example embodiments of the present disclosure. As depicted an input 202 can be received by the machine-learned message passing model 200. The input 202 can feed forward through the machine-learned message passing model 200 to generate an output 222. More particularly, the components of the machine-learned message passing model 200 can sequentially operate on the input 202 to generate output 222. As an example, nodes 204 and 206 respectively associated with weights W₁₁ and W₁₂ can receive and process the input 202 to generate an intermediate representation of the input 208. Similarly, other components of the model (e.g., bias node 212, activation function node 218, loss node 224, etc.) can generate sequential intermediate representations (e.g., 208, 216, 220, etc.). It should be noted that in some implementations, the intermediate representations (e.g., 208, 216, 220, etc.) can be considered as input messages to an upstream node. As an example, weight nodes 204 and 206 can receive an input message (e.g., input 202) and output an input message 208. Similarly, bias node 212 can generate an input message which can be combined with input message 208 to generate an input message 216 (e.g., by applying the bias value represented by bias node 212 to the input message 208). The input message 216 can be provided to the activation function node 218.

A meta-learning objective function can evaluate a difference between output 222 and input 202 to obtain a loss value associated with the loss node 224. This loss can be backpropagated back through the machine-learned message passing network 200 through the use of message passing learning protocols. As an example, backmessage 215 can be a message from the activation function node 218 which is downstream of the bias node 212. The backmessage 215 can be based at least in part on the loss 224. The bias node 212 can receive the backmessage 215. Based on the backmessage 215, the bias node 212 can generate a multi-dimensional backmessage 210 (e.g., using a machine-learned backmessage generation submodel of the node 212, etc.). Further, the bias node 212 can generate node update 214 (e.g., serialized instructions) for the bias node itself (e.g., using a machine-learned node update submodel of the node 212, etc.). The bias node 212 can apply the node update 214 to update one or more parameters of the bias node 212 (e.g., can send the serialized node update instructions 214 to itself as a downstream backmessage, change the parameter value, etc.). Further, the multi-dimensional backmessage 210 generated by the bias node 212 can be provided to an upstream node (e.g., weight nodes 204 and 206, etc.), which can generate their own multi-dimensional backmessages. In such fashion, the loss 224 can be backpropagated through the machine-learned message passing model without utilizing conventional gradient descent techniques.

FIG. 2B depicts a block diagram of an example node 212 of the machine-learned message passing model 200 according to example embodiments of the present disclosure. More particularly, the node 212 of FIG. 2A can include a machine-learned backmessage generation submodel 212A. The machine-learned backmessage generation submodel 212A can be or otherwise include one or more neural network units and/or neural networks. As an example, the machine-learned backmessage generation submodel 212A can be a multi-layer perceptron, a plurality of gated recurrent units, and/or long short-term memory units. Using the machine-learned backmessage generation submodel 212A, the bias node 212 can generate a multi-dimensional backmessage 210.

Similarly, the bias node 212 can include a machine-learned node update submodel 212B. The machine-learned node update submodel 212B can be or otherwise include one or more neural network units and/or neural networks. As an example, the machine-learned node update submodel 212B can be a multi-layer perceptron that includes a plurality of gated recurrent units and/or long short-term memory units. Using the machine-learned backmessage generation submodel 212B, the bias node 212 can generate a node update 214 (e.g., serialized node update instructions, etc.).

In some implementations, the parameters of the machine-learned backmessage generation submodel 212A and the machine-learned node update submodel 212B can be updated based at least in part on a meta-learning loss function. It should be noted that the multi-dimensional message 210 and the node update 214 of each node of the machine-learned message passing model can be generated at a different frequency than the parameters of the machine-learned submodels (e.g., 212A/212B) are updated. More particularly, the generation of the multi-dimensional message 210 and the node update 214 can occur in an inner loop that corresponds to a k-number of training iterations (e.g., a number of training items in a training batch, a number of training batches in training data, etc.) while the parameter updating of the machine-learned submodels (e.g., 212A/212B) can occur in an outer loop. For example, when the k-number of training iterations is complete, the parameters of the machine-learned submodels (e.g., 212A/212B) can be updated. In some implementations, the parameters of the machine-learned submodels can be updated based on a meta-learning objective function that evaluates a plurality of outputs (e.g., 210/214) of the node corresponding to the k-number of iterations. As an example, the meta-learning objective function may evaluate an average of a plurality of node updates 214 to update parameters of the machine-learned node update submodel 212B and/or the machine-learned backmessage generation submodel 212A. Alternatively, or additionally, in some implementations, the meta-learning objective function can evaluate a difference between the training output (e.g., 222 of FIG. 2A) of the machine-learned message passing model 200 and a ground truth associated with a training input (e.g., 202 of FIG. 2A).

### EXAMPLE METHODS

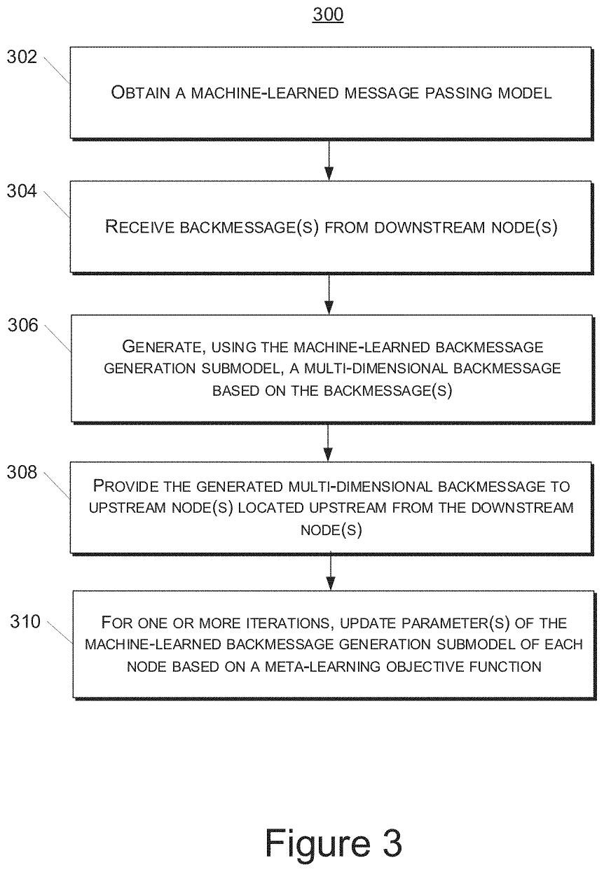

FIG. 3 depicts a flow chart diagram of an example method to perform meta-learning of a machine-learned message passing model according to example embodiments of the present disclosure. Although FIG. 3 depicts steps performed in a particular order for purposes of illustration and discussion, the methods of the present disclosure are not limited to the particularly illustrated order or arrangement. The various steps of the method 300 can be omitted, rearranged, combined, and/or adapted in various ways without deviating from the scope of the present disclosure.

At 302, a computing system can include and/or obtain a machine-learned message passing model. As an example, any component of a machine-learned message passing model (e.g., a weight, a bias, an activation function, a loss, etc.) can be represented by a node in the directed graph. The node in the directed graph can include value(s), a machine-learned backmessage generation submodel, and a machine-learned node update submodel. The forward pass through the machine-learned model (e.g., providing an input to the model to receive an output) can be accomplished in the same manner as a traditional gradient-based approach. In the backwards training pass (e.g., the adjustment of parameters of the model, etc.), each node can receive a k-dimensional message vector. Based on the k-dimensional message vector, each node can update its own value (e.g., a weight for a node corresponding to a weight, etc.) using a machine-learned node update submodel of the node (e.g., a multilayer perceptron, a long short-term memory unit, a gated recurrent unit, etc.). Further, each of the nodes can backpropagate an additional modified k-dimensional message vector generated using the node's machine-learned backmessage generation submodel (e.g., a multilayer perceptron, a long short-term memory unit, a gated recurrent unit, etc.). The parameters of each of the nodes machine-learned submodel(s) (e.g., the machine-learned backmessage generation submodel and/or the machine-learned node update submodel) can be updated based on a meta-learning objective function that evaluates a training output of the machine-learned message passing model.

More particularly, the machine-learned message passing model, in some implementations, can be or can otherwise include one or more neural networks (e.g., deep neural networks) or the like. Neural networks (e.g., deep neural networks) can be feed-forward neural networks, convolutional neural networks, and/or various other types of neural networks. The machine-learned message passing model can be include a plurality of nodes (e.g., organized in a directed graph, etc.). One or more of these nodes can respectively include a machine-learned backmessage generation submodel.

In some implementations, the machine-learned backmessage generation submodel can be or otherwise include one or more neural network units. As an example, the machine-learned backmessage generation submodel can include one or more multi-layer perceptrons. As another example, the machine-learned backmessage generation submodel can include long short-term memory units. As yet another the machine-learned backmessage generation submodel can include gated recurrent units. Alternatively, or additionally, in some implementations, the machine-learned backmessage generation submodel can be or otherwise include one or more additional neural networks (e.g., a recurrent neural network, a multi-layer perceptron, etc.).

At 304, the one or more nodes of the machine-learned message passing model of the computing system can be configured to receive at least one backmessage from at least one downstream node that is located downstream from the node. As an example, the plurality of nodes of the machine-learned message passing model can be structured in a series of consecutive layers that sequentially process an input to generate an output. The last layer of node(s) of the machine-learned message passing model (e.g., the layer of node(s) that generate the final output) can be considered the most “downstream” node(s) of the machine-learned message passing model, while the first layer of node(s) (e.g., the layer of nodes that first processes the input, etc.) can be considered the most “upstream” node(s) of the machine-learned message passing model. It should be noted that, as described, a node can be considered downstream of itself. More particularly, a node can send a backmessage to itself (e.g., a message including a serializable list of operations computed in order to update the status of the node, etc.) and the backmessage can be received as a backmessage from a downstream node. As such, a node included in a last “layer” of the machine-learned message passing model can receive a backmessage from a downstream node.

In some implementations, the backmessage received by the node(s) from the downstream node(s) can be a multi-dimensional backmessage (e.g., a multi-dimensional vector, etc.). The multi-dimensional backmessage can be represented by or structured as any conventional multi-dimensional data structure. The multi-dimensional backmessage can be based on, include, or otherwise represent a serializable list of operations that a node (e.g., a downstream node, etc.) computed in order to update the state of the node. Alternatively, or additionally, in some implementations, the message can be a latent space encoding configured to provide node update information to the node.

It should be noted that the machine-learned message passing model is described as being structured in “layers” merely to more aptly illustrate the various embodiments of the present disclosure. More particularly, the machine-learned message passing model does not necessarily need to be structured in layers, and can instead be structured in any manner that facilitates communication of messages between nodes of the machine-learned message passing model

At 306, the one or more nodes of the machine-learned message passing model of the computing system can be configured to generate, using the machine-learned backmessage generation submodel, a multi-dimensional backmessage based on the at least one backmessage received by the node from the at least one downstream node. As an example, a feed-forward neural network can be seen as a special case of a directed graph. The types of nodes can correspond to components of a neural network (e.g., weights, biases, activations, losses, etc.). Every node can include a forward and a backward arrow. The forward arrow can compute one-dimensional outputs from one-dimensional inputs, as performed in conventional neural network architectures. As an example, a forward step of a weight can be represented as y=w·x. The machine-learned message passing model can explicitly store the input values received to later be passed in the backward pass (e.g., how backpropagation requires the input values to compute gradients, etc.).

However, under a message passing learning protocol (e.g., the protocol of the machine-learned message passing model, etc.), the backward pass through the machine-learned message passing model (e.g., the communication of backmessages between nodes, etc.) can utilize every node to compute a backmessage to send back to an upstream node, given its forward input received in the forward pass, the backmessage received from the one or more downstream node(s), and any internal states of the node (e.g., weights or bias values, GRU/LSTM carry/hidden states, a nodes embedding for personalization, etc.). It should be noted that this framework allows for a variety of possible architectures, and as such is not limited to traditional feed forward neural network implementations.

As an example, this function (e.g., the message passing rule, etc.) can be formally represented as a machine-learned backmessage generation submodel g. As an example, for a node i, the message mᵢ can be computed from a message mⱼ, forward input xᵢ and internal states hᵢ (weight/bias values, carry states):

mᵢ^{t}=g(mⱼ, xᵢ, hᵢ)

However, losses and activation components of the machine-learned message passing model generally have no parameters to update, so the internal states can generally consist of carry states, if a stateful learner is utilized. Moreover, while a message mⱼ can be k-dimensional with typically k>1, the input message to a loss function can generally be 1-dimensional, and can be considered as the loss itself. However, it should be noted that while the input message (e.g., the message received by these node(s) during the forward pass, etc.) can be 1-dimensional, the backmessage generated by these nodes (e.g., loss node(s), activation node(s), etc.) can be multi-dimensional.

Further, in some implementations, each of the one or more nodes can be updated with the machine-learned node update submodel of the node. More particularly, some node(s) (e.g., weight node(s), bias node(s), etc.) can utilize their own machine-learned node update submodel to determine a node update f wherein:

Δwᵢⱼ^{t}=f(mⱼ, xᵢ^{t}, hᵢ^{t})

for a batch of size B, f can be computed B times, and then averaged to compute the final update:

wᵢⱼ^{t+1}=wᵢⱼ^{t}+ΣBΔwᵢⱼ^{t}

which can be applied to the node to update the node. More particularly, the machine-learned node update submodel can generate a plurality of updates to the node (e.g., corresponding to a batch size of a training input batch, etc.) and can then average the plurality of updates to receive a final update to apply to the node.

As an example, given a traditional dense machine-learned message passing model layer of size N*M, some of the messages can require replication, while others may require aggregation. As such, a line of nodes M (e.g., bias node(s), etc.) can replicate each of their generated messages N times, as they are connected to N nodes (e.g., weight node(s), etc.). Similarly, the output message of a dense layer of node(s) can be expected to be N messages. This can be performed, in some implementations, by averaging the messages for each “column” of nodes (e.g., a layer, a grouping of nodes by node type, etc.).

It should be noted that, in some implementations, the nodes and respective f functions (e.g., machine-learned node update submodels) and g functions (e.g., machine-learned backmessage generation submodels), can be implemented either by stateful or stateless models. As an example, stateful gated recurrent unit based models can be utilized (e.g., as a multilayer perceptron model, in addition to a multilayer perceptron model, etc.). For example, the stateful gated recurrent unit based models can be represented formally as:

u=σ(x*Wᵤₓ+c^{t}*W_{uc}+bᵤ)

r=σ(x*Wᵣₓ+c^{t}* W_{rc}+bᵣ)

c^{t+1}=u·c^{t}+(1−u)·tanh(MLPₓ(x)+MLP_{c}(c^{t}r)+bₙ)

wherein the multilayer perceptrons (e.g., MLP's, etc.) can include two hidden layers of different sizes (e.g., size 80 and 40 respectively, etc.) with associated activation functions (e.g., ReLu activation functions, etc.). Some of the carry states can be considered as output messages, and weight updates for nodes corresponding to weights and biases. Alternatively, in some implementations, a stateless version of the above example can be utilized. For example, a multilayer perceptron can be used for f (e.g., the machine-learned node update submodel) and for g (e.g., the machine-learned backmessage generation submodel). Both of the submodels can include two hidden layers of size 80 and 40 respectively with ReLu activations, and a tanh activation for the final layer.

In some implementations, one or more nodes of the machine-learned message passing model can include one or more embeddings. More particularly, each of one or more nodes of the nodes of the machine-learned message passing model can include one or more embeddings configured to add additional personalization to each of the node(s). The utilization and implementation of embeddings and embedding generation techniques can be performed using any conventional embedding techniques (e.g., machine-learned embedding generation, conventional embedding generation, etc.).

In some implementations, the machine-learned message passing model can be initialized before training the model and/or using the model. More particularly, for any f inputs (e.g., inputs to the machine-learned node update submodel, etc.) and g inputs (e.g., inputs to the machine-learned backmessage generation submodel, etc.), input messages, carry states, inputs to the forward step, and optional weights can all possess different means and magnitudes. As such, the differences between means and magnitudes can be reduced or eliminated by performing one or more minibatch operations and standardizing the inputs to the machine-learned submodels individually. The values used (e.g., mean, standard deviation, etc.), can be kept fixed, and therefore can be reused thorough the machine-learned submodels lifetime. Similarly, the outputs of the f models (e.g., the machine-learned node update submodel(s) can be bounded by (−1, 1) by a tanh function. This range can cause the model to be too sensitive to changes during early training. As such, the outputs of the machine-learned node update submodels can be translated to have a mean of zero, and can be scaled down to a predetermined maximum size (e.g., the layer's W standard deviation divided by 5, etc.). In some implementations, the output scaling can be the only trainable variable. Alternatively, in some implementations, other variables can be trained in addition to output scaling. It should be noted that batch normalization is not necessarily the only configuration that can be utilized by the present disclosure. Instead, any different conventional standardization techniques, such as batch normalization, can be utilized.

In some implementations, a “line” of nodes (e.g., (one or more weight nodes, one or more bias nodes, one or more activation nodes, one or more loss nodes, etc.) can share a machine-learned backmessage generation submodel and a machine-learned node update submodel. More particularly, the nodes in a “line” can use the same model parameters for each of their own respective machine-learned submodels. Alternatively, or additionally, each node in a layer can share the same parameters in a substantially similar manner

At 308, the one or more nodes of the machine-learned message passing model of the computing system can be configured to provide the generated multi-dimensional backmessage to upstream node(s) located upstream from the downstream node(s).

At 310, the computing system can be configured, for one or more iterations, to update, for each of the one or more nodes, one or more parameters of the machine-learned backmessage generation submodel of the node based on a meta-learning objective function. More particularly, in some implementations, a cross-validation loss can be evaluated by the meta-learning objective function after performing k-step learning (e.g., evaluating the quality of the learnt parameters on unseen data). Additionally, or alternatively, the meta-learning objective function can further evaluate a “hint loss” that, after every step, reinforces the model to correctly classify the input-output pairs included in training input data as it is observed. Additionally, in some implementations, the meta-learning objective function can be evaluated using an adaptive optimizer (e.g., ADAM, etc.) to normalize the gradient(s) for each variable associated with a node

### ADDITIONAL DISCLOSURE

The technology discussed herein makes reference to servers, databases, software applications, and other computer-based systems, as well as actions taken and information sent to and from such systems. The inherent flexibility of computer-based systems allows for a great variety of possible configurations, combinations, and divisions of tasks and functionality between and among components. For instance, processes discussed herein can be implemented using a single device or component or multiple devices or components working in combination. Databases and applications can be implemented on a single system or distributed across multiple systems. Distributed components can operate sequentially or in parallel.

While the present subject matter has been described in detail with respect to various specific example embodiments thereof, each example is provided by way of explanation, not limitation of the disclosure. Those skilled in the art, upon attaining an understanding of the foregoing, can readily produce alterations to, variations of, and equivalents to such embodiments. Accordingly, the subject disclosure does not preclude inclusion of such modifications, variations and/or additions to the present subject matter as would be readily apparent to one of ordinary skill in the art. For instance, features illustrated or described as part of one embodiment can be used with another embodiment to yield a still further embodiment. Thus, it is intended that the present disclosure cover such alterations, variations, and equivalents.

What is claimed is:

1. A computing system for training a machine-learned message passing model, comprising:
one or more processors; and
one or more non-transitory computer-readable media that collectively store:
a machine-learned message passing model that is end-to-end differentiable, the machine-learned message passing model comprising a plurality of nodes, wherein each of one or more nodes of the plurality of nodes respectively comprises a machine-learned backmessage generation submodel, each of the one or more nodes configured to:
receive at least one backmessage from at least one downstream node that is located downstream from the node, wherein the at least one backmessage is generated based on a training output of the machine-learned message passing model;
generate, using the machine-learned backmessage generation submodel, a multi-dimensional backmessage based on the at least one backmessage received by the node from the at least one downstream node; and
provide the multi-dimensional backmessage to at least one upstream node that is located upstream from the node; and
a first set of instructions that, when executed by the one or more processors, cause the computing system to perform operations, the operations comprising:
for one or more iterations, updating, for each of the one or more nodes, one or more parameters of the machine-learned backmessage generation submodel of the node based on a meta-learning objective function.

2. The computing system of claim 1, wherein:
each of the one or more nodes further comprises a machine-learned node update submodel; and
the operations further comprise:
updating, for each of the one or more nodes, one or more parameters of the node using the machine-learned node update submodel of the node.

3. The computing system of claim 2, further comprising updating, for each of the one or more nodes, one or more parameters of the machine-learned node update submodel of the node based at least in part on the meta-learning objective function.

4. The computing system of claim 1, wherein each of the plurality of nodes comprises a node type, the node type comprising:
a loss node;
a weight node;
an activation node; or
a bias node.

5. The computing system of claim 4, wherein each of the plurality of nodes is structured in one or more layers based on the node type of each of the plurality of nodes.

6. The computing system of claim 5, wherein, for each of the one or more layers, each node of the layer shares, between each node of the layer, one or more parameter values for at least one of the machine-learned backmessage generation submodel or the machine-learned node update submodel.

8. The computing system of claim 1, wherein the meta-learning objective function evaluates an average update from one or more updates applied to the machine-learned backmessage generation submodel over the one or more iterations

9. The computing system of claim 1, wherein providing the multi-dimensional backmessage to the at least one upstream node that is located upstream from the node further comprises providing, in addition to the multi-dimensional backmessage, a loss gradient to the at least one upstream node located upstream from the node.

10. The computing system of claim 2, wherein at least one of the machine-learned backmessage generation submodel or the machine-learned node update submodel comprises a neural network, wherein the neural network comprises at least one of:
one or more gated recurrent units;
one or more long short-term memory units; or
a multi-layer perceptron.

11. The computing system of claim 1, wherein each node of the one or more nodes is further configured to forward-pass a multi-dimensional message vector to at least one downstream node that is located downstream from the node.

12. The computing system of claim 1, wherein the multi-dimensional backmessage comprises at least a portion of a forward-pass message vector previously received by the node from an upstream node that is located upstream from the node.

13. A computer-implemented method for processing data using a machine-learned message passing model, the method comprising:
obtaining, by a computing system comprising one or more computing devices, input data, wherein the input data is associated with a task;
inputting, by the computing system, the input data to the machine-learned message passing model trained to perform the task associated with the input data, wherein the machine-learned message passing model comprises a plurality of nodes, each node of the plurality of nodes trained using at least a machine-learned backmessage generation submodel of the node; and
receiving, by the computing system as an output of the machine-learned message passing model, output data, wherein the output data is based at least in part on the input data and corresponds to the task associated with the input data.

14. The computer-implemented method of claim 13, wherein each of the plurality of nodes is further trained using a machine-learned node update submodel of the node.

15. The computer-implemented method of claim 13, wherein;
the input data comprises image data depicting one or more objects;
the task associated with the image data is an object recognition task; and
the output data comprises object recognition data describing at least one of the one or more objects depicted by the image data

16. The computer-implemented method of claim 14, wherein at least one of the machine-learned backmessage generation submodel or the machine-learned node update submodel comprises a neural network, wherein the neural network comprises at least one of:
one or more gated recurrent units;
one or more long short-term memory units; or
a multi-layer perceptron.

17. The computer-implemented method of claim 13, wherein the input data comprises a feature vector generated by a machine-learned model different and distinct from the machine-learned message passing mode.

18. One or more tangible, non-transitory computer readable media storing computer-readable instructions that when executed by one or more processors cause the one or more processors to perform operations, the operations comprising:
obtaining training data and a machine-learned message passing model, wherein the machine-learned message passing model comprises a plurality of nodes, wherein each of one or more nodes of the plurality of nodes respectively comprises a machine-learned backmessage generation submodel, each of the one or more nodes configured to:
receive at least one backmessage from at least one downstream node that is located downstream from the node, wherein the at least one backmessage is generated based on a training output of the machine-learned message passing model;
generate, using the machine-learned backmessage generation submodel, a multi-dimensional backmessage based on the at least one backmessage received by the node from the at least one downstream node; and
provide the multi-dimensional backmessage to at least one upstream node that is located upstream from the node; and
for one or more iterations:
inputting the training data to the machine-learned message passing model to receive the training output; and
updating, for each of the one or more nodes, one or more parameters of the node based on the at least one backmessage received by the node.

19. The tangible, non-transitory computer readable media of claim 18, wherein:
each of the plurality of nodes further comprises a machine-learned node update submodel; and;
for each of the one or more nodes, the one or more parameters of the node are updated based on the at least one backmessage using the machine-learned node update submodel of the node.

20. The tangible, non-transitory computer readable media of claim 19, wherein at least one of the machine-learned backmessage generation submodel or the machine-learned node update submodel comprises a neural network, wherein the neural network comprises at least one of:
one or more gated recurrent units;
one or more long short-term memory units; or
a multi-layer perceptron.
